(19) United States
(12) Patent Application Publication
(10) Pub. No.: US 2020/0324366 A1
(43) Pub. Date: Oct. 15, 2020

(54) GALVANO DEVICE AND LASER MACHINING APPARATUS

(71) Applicant: CANON KABUSHIKI KAISHA, Tokyo (JP)

(72) Inventors: Hiroto Yoshii, Utsunomiya-shi (JP); Yukie Kuroki, Utsunomiya-shi (JP)

(21) Appl. No.: 16/843,102

(22) Filed: Apr. 8, 2020

(30) Foreign Application Priority Data
Apr. 15, 2019 (JP) 2019-077386

(51) Int. Cl. B23K 26/042; B23K 26/082; G05B 19/4155

(52) U.S. Cl. CPC B23K 26/042; G05B 2219/45165; G05B 19/4155; B23K 26/082

(57) ABSTRACT

A galvano device that rotates a mirror provided at a motor shaft by rotating a motor and changes a direction of light by allowing the mirror to reflect the light includes a sensor configured to detect a rotation angle of a motor rotating shaft and a filter configured to estimate a rotation angle of the mirror from a value output from the sensor. The rotation angle of the mirror is output from the filter.

### BACKGROUND

### Field of the Disclosure

The present disclosure relates to a galvano device and a laser machining apparatus.

### Description of the Related Art

Galvano devices are used in laser machining apparatuses (machine tools) such as a laser drilling apparatus, a laser trimming apparatus, and a laser repair apparatus. While controlling a rotation angle of a mirror attached to a rotating shaft of a motor, a galvano device reflects laser light by the mirror and irradiates a target position with the laser light. To highly accurately determine an irradiation position of the laser light at the target position, the rotation angle of the mirror needs to be controlled highly accurately (refer to Japanese Patent Laid-Open No. 2011-253125). The galvano device includes a rotary encoder or the like provided on the rotating shaft of the motor.

Regarding such a galvano device of the related art, a rotation angle of the motor, which is indicated by a measurement value of the rotary encoder provided on the rotating shaft of the motor, is considered to be the same as the rotation angle of the mirror, on the assumption that the rotating shaft of the motor and the mirror form a perfectly rigid body as a whole without flexibility.

### SUMMARY

A galvano device as an aspect of the present disclosure rotates a mirror provided at a motor shaft by rotating a motor and changes a direction of light by allowing the mirror to reflect the light. The galvano device includes a sensor configured to detect a rotation angle of a motor rotating shaft and a filter configured to estimate a rotation angle of the mirror from a value output from the sensor. The rotation angle of the mirror is output from the filter.

Further features of the present disclosure will become apparent from the following description of exemplary embodiments with reference to the attached drawings.

### BRIEF DESCRIPTION OF THE DRAWINGS

FIG. 1 illustrates a configuration of a galvano device.

FIG. 2 is a block diagram of details of an arithmetic unit according to a first embodiment.

FIG. 3 illustrates a complex of a motor and a mirror.

FIG. 4 is a graph showing the result of structural analysis of the complex of the motor and the mirror.

FIG. 5 is a flowchart of operations of a filter parameter estimation unit.

FIGS. 6A and 6B are graphs showing deviations between estimation results and respective actual rotation angles.

FIG. 7 is a block diagram of details of an arithmetic unit according to a second embodiment.

FIG. 8 illustrates a laser machining apparatus according to a third embodiment.

### DESCRIPTION OF THE EMBODIMENTS

Hereinafter, feasible embodiments according to the present disclosure will be described in detail with reference to the attached drawings.

### First Embodiment

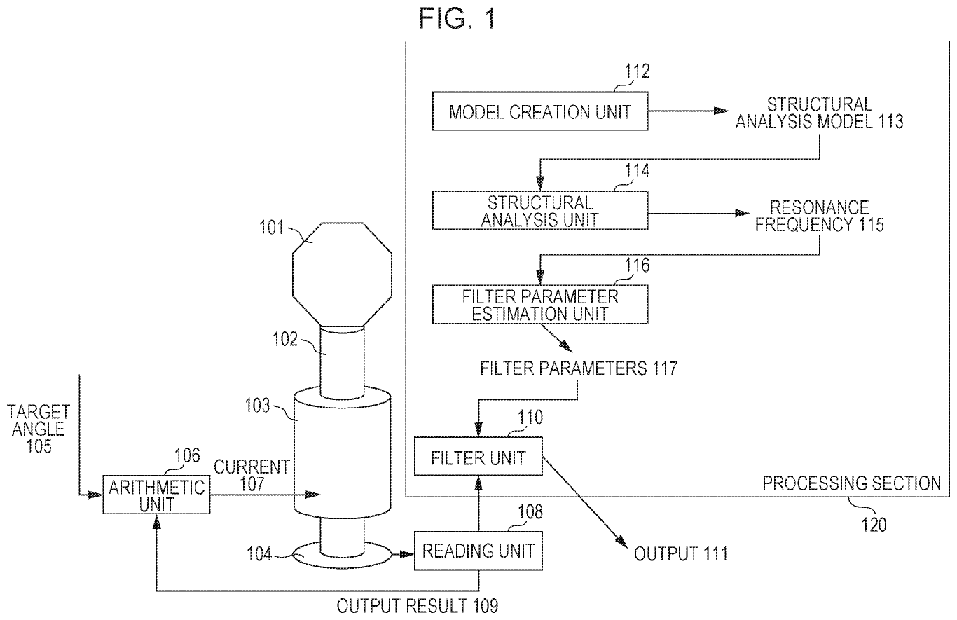

FIG. 1 illustrates a configuration of a galvano device according to a first embodiment. The galvano device rotates a mirror provided at a motor shaft by rotating a motor and changes a direction of light by allowing the mirror to reflect the light. The galvano device according to the present embodiment includes a mirror 101, a motor rotating shaft 102, a motor 103, a scale 104, an arithmetic unit 106, a reading unit (sensor) 108, and a processing section 120.

The scale 104 and the reading unit 108 constitute a detector that detects rotation angles. For example, an optical or magnetic encoder serves as such a detector. Other than this configuration, for example, a capacitance sensor can be used.

The arithmetic unit 106 includes a controller, determines a target current 107 allowing the motor 103 to rotate at a target angle 105 that is input into the arithmetic unit 106, and controls a rotation angle of the motor 103 by feeding current through the motor 103.

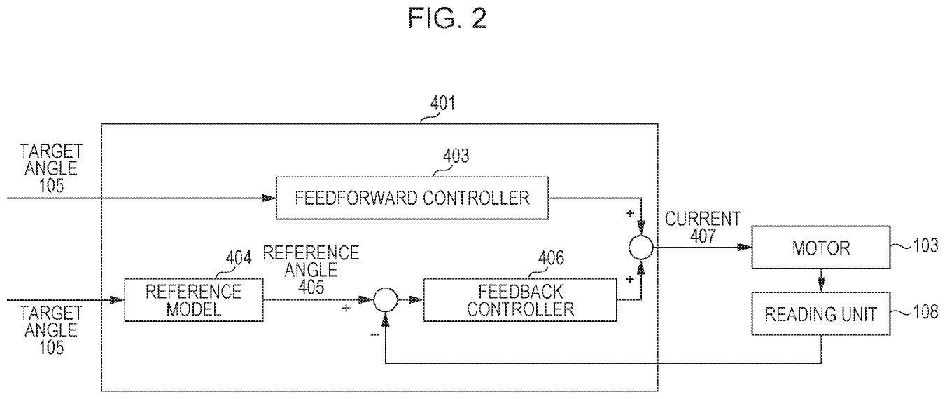

The arithmetic unit 106 will be described in detail with reference to FIG. 2. FIG. 2 exemplifies a “two degrees of freedom control system” by a block diagram. A portion enclosed in frame 401 serves as the arithmetic unit 106. The arithmetic unit 106 is configured of a feedforward controller 403, a reference model 404, and a feedback controller 406. The feedforward controller 403 is an arithmetic machine that performs an arithmetic operation by multiplying an inverse function of an input-output function by the reference model 404, when the input value of the motor is current and the output value of the motor is the rotation angle. The reference model 404 is a calculating machine that calculates the relationship between the target angle 105 and a reference angle 405 that is an angle intended by a user during operation. For example, a low pass filter is used for the reference model 404. The target angle 105 is input into each of the feedforward controller 403 and the reference model 404. The feedforward controller 403 outputs a current value in accordance with the target angle 105. The reference model 404 outputs the reference angle 405 in accordance with the target angle 105, and the difference between the reference angle 405 and the output from the reading unit 108 is input into the feedback controller 406. A current 407 that is the total of the output from the feedforward controller 403 and the output from the feedback controller 406 is input into the motor 103. A measurement value is output from the reading unit 108 in accordance with the rotation angle of the motor 103. In the feedback controller 406, a parameter or the like is designed so as to minimize the difference between the reference angle 405 and the output value of the reading unit 108 in a loop of the feedback controller 406, the motor 103, and the reading unit 108.

The control shown in FIG. 2 may be achieved by a digital control system with a digital signal processor (DSP) or the like or by an analog control system with an analog electric circuit. In addition, the arithmetic unit 106, which calculates the current 107 that drives the motor 103 from the target angle 105, is not limited to the two degrees of freedom control system that is described herein, and any control system may be used.

The rotation angle of the motor rotating shaft 102 is measured by the reading unit 108 reading the scale 104. In an existing way, the rotation angle of the mirror 101 is indirectly controlled by controlling the rotation angle of the motor rotating shaft 102 because the rotation angle of the motor rotating shaft 102 and the rotation angle of the mirror 101 are considered to be the same. In this case, the target angle 105 is considered to be the target rotation angle of the motor rotating shaft 102, and an output result 109 of the reading unit 108 is considered to be an actual rotation angle of the motor rotating shaft 102.

However, the rotation angle indicated by the scale 104 and the rotation angle of the mirror 101 slightly deviate from each other because the mirror 101 attached to a distal end of the motor rotating shaft 102 is disposed at a distance from the scale 104 and the motor rotating shaft 102 and the mirror 101 are not formed as a perfectly rigid body. In particular, when the mirror 101 is at one end of the rotating shaft and the scale 104 is at the other end of the rotating shaft, such a deviation between the rotation angles should be noted. That is, in a strict sense, a complex of the motor and the mirror has a vibration property, and the rotation angle of the motor and the rotation angle of the mirror may deviate slightly from each other. Therefore, a measurement value of a rotary encoder and an actual rotation angle of the mirror may deviate from each other. When the galvano device is used for a laser machining apparatus or the like, a slight deviation between the rotation angle of the motor and the rotation angle of the mirror has a great influence on machining results. The same applies to the mirror 101 and the motor rotating shaft 102. Thus, there may be the case in which the output result 109 of the reading unit 108 does not accurately represent the rotation angle of the mirror 101.

Therefore, in the present embodiment, by passing the output of the reading unit 108 through a filter, a value in which such a deviation is reduced and which is closer to a true value of the rotation angle of the mirror 101 is output. To be more specific, a parameter or the like of a filter unit (filter) 110 is set and configured so that an output 111 of the filter unit 110 of the processing section 120 represents a value close to the true value of the rotation angle of the mirror 101.

The filter unit 110 will be described in detail using equation 1. Equation 1 shows an example of a transfer function used in the filter unit 110.

In equation 1, S is the Laplace operator. N is the number of modes, an is twice the modal damping ratio, βn is a resonance frequency, kn is the gain of a mode, and k0 is the gain of a rigid-body model. Here, “mode” represents a maximum value of a frequency response characteristic. In equation 1, the numerator represents a model of the mirror 101, and the denominator represents a model of the motor 103.

The model of the mirror is a model having a plurality of (N) resonance frequencies, and the model of the motor is a simple rigid-body model. To be more specific, the filter unit 110 performs calculation by converting the equation and the models represented by the transfer function of equation 1 to a difference equation and by converting the output values of the reading unit 108 in every clock cycle so as to obtain values close to the respective true rotation angles of the mirror 101.

In the filter unit 110, digital signal processing may be performed, or such a continuous equation shown in equation 1 may be implemented by using an analog circuit. Any transfer function other than the transfer function of equation 1 may be used provided that the transfer function is a calculation model that can be used to logically construct the filter. However, regardless of the type of transfer function used, a vibration property of an actual object (a complex of a mirror and a motor rotating shaft) is needed as a parameter.

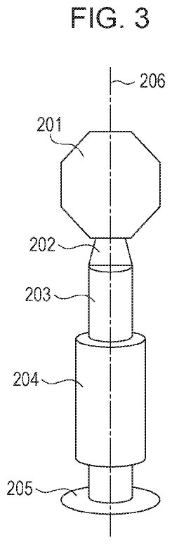

Next, the flow for estimating parameters used in the filter unit 110 will be described with reference to FIG. 1. The processing section 120 is configured of various arithmetic processing units and includes the following units. First, a complex of the mirror 101 and the motor rotating shaft 102 is modeled by a model creation unit 112. A specific example of a created structural analysis model 113 is illustrated in FIG. 3. FIG. 3 is a model diagram of an inner structure of the galvano device (101 to 104) in FIG. 1 from which a coil part of the motor is excluded. The model is configured of a mirror 201, a mirror attachment portion 202, a motor rotating shaft 203, a magnet 204, and a scale 205. When the complex of the mirror 101 and the motor rotating shaft 102 is modeled in a more precise manner, screws and nuts are further included, and a complex of about ten rigid bodies may be modeled. It is relatively easy to obtain the moment of inertia around a rotation axis 206 of a model of the complex of the mirror and the motor rotating shaft (the structural analysis model) in FIG. 3 because the shape and density of each component is obtained.

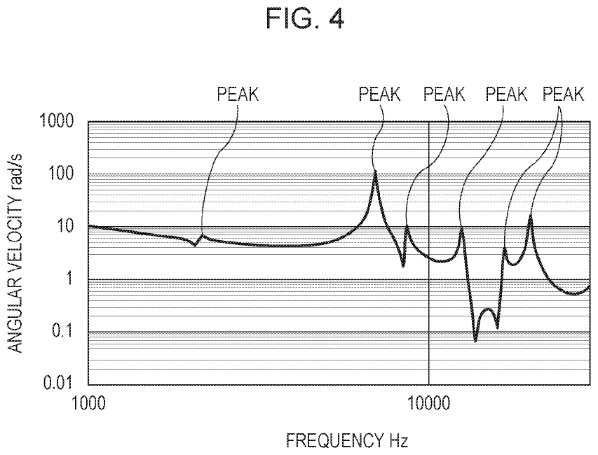

Once the structural analysis model 113 is created, frequency-response analysis can be performed by executing a structural analysis unit 114 using a method such as a finite element method. Consequently, a resonance frequency 115 of the complex of the mirror and the motor rotating shaft is obtained. To be more specific, the frequency-response characteristic is simulated by rotating the structural analysis model by applying a force with reference to the rotation axis 206 in FIG. 3. An example of the result is shown in FIG. 4. The number of resonance frequencies of the structural analysis model is considered to be six because the number of peaks (maximum values) of angular velocity is six on a graph in FIG. 4. Thus, N in equation 1 is six.

The resonance frequency of the complex of the mirror and the motor rotating shaft can actually be measured by using an expensive apparatus such as a laser Doppler vibrometer; however, the model creation unit 112 and the structural analysis unit 114 are used in the present embodiment. The method has three advantages.

The first advantage is that the method is realized at a low cost. The number of components constituting the structure is at most about ten as illustrated in FIG. 3, and the density of the material of each component can be easily obtained from a catalog or the like. Thus, a complex of a mirror and a motor rotating shaft can be modeled in a short time period, even if the complex of the mirror and the motor rotating shaft has a highly complex structure. Once a model is created, a resonance frequency can be easily obtained at a low cost because a physical simulation has only to be performed by software and an information processing apparatus.

The second advantage is that a resonance frequency can be obtained even if the resonance frequency has a small peak. For example, a value of the leftmost frequency peak (around 2000 Hz) on the graph in FIG. 4 is extremely low; thus, such a value cannot be obtained by a method actually measuring resonance frequency. In the present embodiment, a resonance frequency having a small peak can be obtained. Thus, it is possible to construct the filter unit 110 so as to output a more precise rotation angle of the mirror.

The third advantage is visualization of a resonance frequency and of deformation of the model corresponding to the frequency. When the structural analysis unit 114 is executed using the finite element method or the like, it is possible to obtain paired information of the way the structural analysis model deforms and resonance frequency. By utilizing the results, a frequency corresponding to deformation that can be ignored in operation of the galvano device can be ignored. Thus, the filter unit 110 can be constructed more easily.

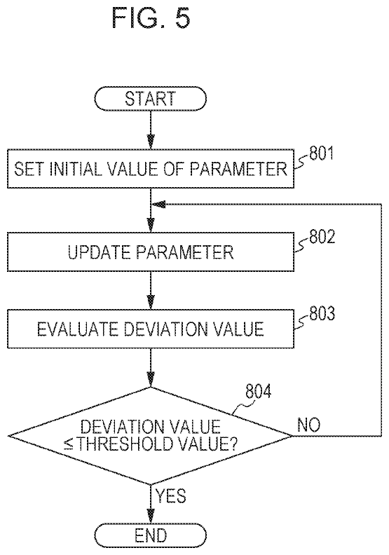

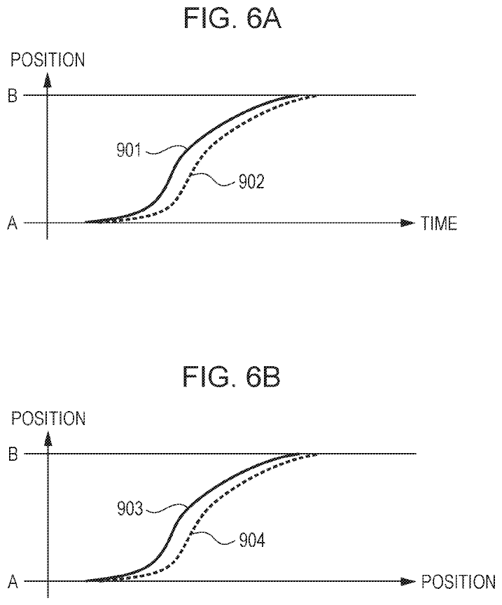

Next, a filter parameter estimation unit 116 will be described in detail with reference to FIGS. 5, 6A, and 6B. As shown in equation 1, the number of parameters used in the filter unit 110 is, more specifically, the total of k0, k1, α1, β1, k2, α2, β2, . . . , kN, αN, and βN in equation 1 (namely, 1+3N parameters). That is, the filter unit 110 can be constructed if such parameters are determined. A flowchart of the process is shown in FIG. 5. As an example, a sequential search method for obtaining a local optimal value is shown in FIG. 5, and a method for obtaining a global optimal value may alternatively be used.

Step 801 is a step for setting initial values of the parameters. In this step, a resonance frequency of βn is obtained in advance by actually measuring or by the structural analysis unit 114, and the obtained resonance frequency is used. Step 801 may be performed randomly several times to prevent an estimated optimal parameter from being trapped in local minimum.

Next, step 802 for updating the parameters is performed. At this time, the parameters (kn and αn) other than the frequency parameters may be modified, or the resonance frequency βn may be modified. The parameters may be updated by a “steepest-descent method” or by a random operation and feedback as with an enforced learning system.

After the parameters are once updated, the result of the reading unit 108, which is actually measured, is converted to an estimate of the rotation angle of the mirror by using an equation (equation 1) described by the updated parameters. In step 803, a deviation between the estimate and the actually measured rotation angle of the mirror is evaluated.

Operations of step 803 will be described with reference to FIGS. 6A and 6B. To measure the actual rotation angle of the mirror, for example, light is applied to the mirror 101, and the position of the reflected light is captured by a camera and tracked. Due to such an operation, slight rotation of the mirror 101 can be magnified. The results from the operation are shown as a graph in FIG. 6A. The abscissa indicates time, and the ordinate indicates the position of the light reflected by the mirror 101. Curved solid line 901 indicates the position of the light actually reflected by the mirror 101, and it is shown that the position is moved from location A to location B as time period elapses. Curved dotted line 902, on the other hand, is the locus of the calculated position of the reflected light using the output value from the filter unit 110 that includes the parameters that have been updated in step 802. The difference (distance) between curved line 901 and curved line 902 corresponds to the deviation value that is obtained through step 802.

If such a method for tracking the change of the position of the reflected light over time cannot be conducted easily, another method may be used. For example, the galvano device is installed in a laser machining apparatus, which will be described below, and a deviation value is obtained by actually machining an object such as a substrate. For example, the machining locus as shown by solid line 903 in FIG. 6B is formed on the object by laser machining the substrate or the like placed on a stage that moves at a constant velocity. That is, the time axis can be converted to the direction axis by using the stage that moves at a constant velocity. In FIG. 6B, the abscissa indicates the position of the stage. Dotted line 904 indicates the machining locus (locus of simulation values) calculated by using values output from the filter unit 110 that includes the updated parameters. In this case, a deviation value between solid line 903 and dotted line 904 corresponds to the deviation value obtained through step 803.

Finally, in step 804, whether the deviation value obtained through step 803 is less than or equal to a threshold value is determined. If the deviation value is less than or equal to the threshold value, the process ends, and, if the deviation value is more than the threshold value, the process returns to the updating of the parameters in step 802. Steps 802, 803, and 804 are repeated until the deviation value reaches a value less than or equal to the threshold value.

Filter parameters 117 that have been obtained by the filter parameter estimation unit 116 are set in the filter unit 110. The filter unit 110 converts (corrects) data output from the reading unit 108 by using the filter parameters 117 that have been set, and the filter unit 110 outputs the data to the outside of the processing section 120. Such a value output as described above is closer to the true rotation angle of the mirror 101. The value may be output to another controller or to a display unit such as a monitor.

As described above, according to the present embodiment, the filter unit 110 can output a rotation angle of the mirror close to a true rotation angle of the mirror by converting the output of the reading unit 108. Therefore, the rotation angle of the mirror can be measured precisely.

### Second Embodiment

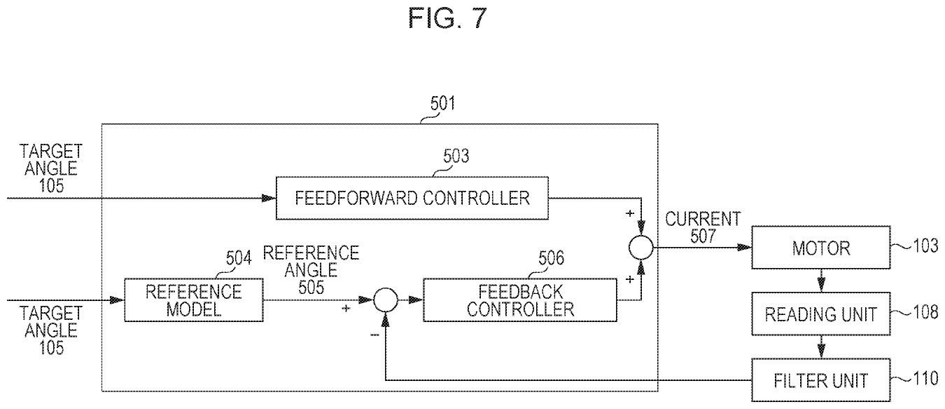

Next, a galvano device according to a second embodiment will be described. The galvano device according to the present embodiment includes an arithmetic unit 106 that has a different configuration from that of the arithmetic unit 106 of the galvano device according to the first embodiment. The arithmetic unit 106 according to the second embodiment will be described with reference to FIG. 7. FIG. 7 is a block diagram showing a control method of the arithmetic unit 106. A portion enclosed in frame 501 serves as the arithmetic unit 106 according the present embodiment. The arithmetic unit 106 is configured of a feedforward controller 503, a reference model 504, and a feedback controller 506.

The target angle 105 is input into each of the feedforward controller 503 and the reference model 504. The feedforward controller 503 outputs a current value in accordance with the target angle 105. The reference model 504 outputs a reference angle 505 in accordance with the target angle 105, and the difference between the reference angle 505 and the output from the reading unit 108 is input into the feedback controller 506. A current 507 that is the total of the output from the feedforward controller 503 and the output from the feedback controller 506 is input into the motor 103. A measurement value is output from the reading unit 108 in accordance with the rotation angle of the motor 103. The feedback controller 506 is designed so as to minimize the difference between the reference angle 505 and the output value of the filter unit 110 in a loop of the feedback controller 506, the motor 103, the reading unit 108, and the filter unit 110.

The reference model 504 is the same as the reference model 404 described with reference to FIG. 2. On the other hand, the feedforward controller 503 differs from the feedforward controller 403, and the feedback controller 506 differs from the feedback controller 406. To be more specific, the feedforward controller 403 in FIG. 2 performs an inverse calculation of a physical model for determining the angle of the motor rotating shaft 102 from the current 407. The feedforward controller 503 in FIG. 7, on the other hand, performs an inverse calculation of a physical model for determining the rotation angle of the mirror 101 from the current 507.

In addition, the feedback controller 506 and a value to be input thereinto differ from the feedback controller 406 and a value to be input thereinto, respectively. The reference angle 405 and the reference angle 505 are the same. A value with which the difference is obtained is output directly from the reading unit 108 in the first embodiment; however, in the present embodiment, a value with which the difference is obtained is a value output from the reading unit 108 and then converted by the filter unit 110 to be output.

According to the present embodiment, a value output directly from the reading unit is not input into the arithmetic unit 106; an output of the filter unit 110 is input into the arithmetic unit 106. Thus, the rotation angle of the mirror 101 can be controlled more accurately because the output value from the filter unit 110 indicates a value close to the true rotation angle of the mirror 101.

### Third Embodiment

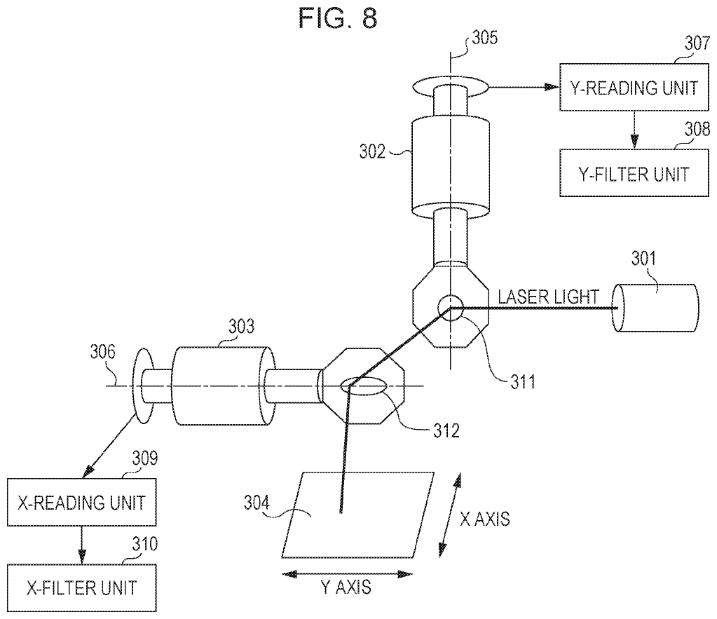

Next, a laser machining apparatus with a galvano device according to the first embodiment or the second embodiment will be described. Examples of the laser machining apparatus include a laser drilling apparatus, a laser trimming apparatus, and a laser repair apparatus. FIG. 8 illustrates a laser machining apparatus according to the present embodiment. In the laser machining apparatus according to the present embodiment, laser light emitted from a laser light source 301 reaches an object 304, which is to be machined, by being reflected off mirrors of two galvano devices.

CO₂ laser and UV-YAG laser are often used as the laser light source 301. Laser output power of the CO₂ laser is larger than that of the UV-YAG laser. Thus, the CO₂ laser can shorten the laser irradiation time period and can be used for machining with high throughput. On the other hand, the UV-YAG laser has a wavelength of 355 nm and the CO₂ laser has a wavelength of 10.6 μm, that is, the UV-YAG laser has a shorter wavelength than that of the CO₂ laser. Thus, it is easier to reduce a spot diameter of a laser beam when the UV-YAG laser is used. A light source is not limited to such laser light sources. In recent years, to increase laser-drilling speed, a multibeam system in which a laser beam from one laser light source is sprit into a plurality of laser beams and a plurality of units of galvano scanners perform light scanning is available.

The laser machining apparatus illustrated in FIG. 8 is referred to as a “two-axis laser machining apparatus”, and the laser machining apparatus can irradiate a targeted position on a two-dimensional surface of the object 304 with laser. As illustrated in FIG. 8, when the X axis and the Y axis that are orthogonal to each other lie in a plane of the object 304, a Y-axis galvano device 302 and an X-axis galvano device 303 are provided. A rotation axis 306 of the X-axis galvano device 303 and a rotation axis 305 of the Y-axis galvano device 302 are orthogonal to each other, and the X axis and the Y axis are each moved independently by rotating the mirrors about the respective rotation axes. In FIG. 8, at first, incident laser light is reflected off the mirror of the Y-axis galvano device 302, and the reflected laser light enters and is reflected off the mirror of the X-axis galvano device 303. However, the order of reflection may be changed.

In FIG. 8, a location at which the laser light is first reflected is set to a substantially central position 311 in the mirror of the Y-axis galvano device 302. In the X-axis galvano device 303, on the other hand, a location at which the laser light is reflected is set to a region 312 extending in the rotation axis 306 direction. This is because a path of the laser light is changed by rotation of the Y-axis galvano device and the rotation axes 305 and 306 are orthogonal to each other.

A Y-reading unit 307 and a Y-filter unit 308 are provided for the Y axis, and an X-reading unit 309 and an X-filter unit 310 are provided for the X axis. Parameters of the Y-filter unit 308 and the X-filter unit 310 may be optimized (tuned) independently, or an integrated parameter set of the entire parameters of both filters may be tuned to be optimized. For example, if the number of parameters of the Y-filter unit 308 is M, and the number of parameters of the X-filter unit 310 is N, parameters of (M+N) are to be optimized when the integrated parameters are tuned. In this case, although a longer time period for optimization is required, further highly accurate filter units can be realized. The results of the tuning of both cases, which are optimizing the parameters independently and optimizing the integrated parameters, may differ from each other because the reflection positions of the laser light, which are the central position 311 and the region 312, differ from each other. That is, the Y-filter unit 308 and the X-filter unit 310 may perform different arithmetic operations and such a case may be optimum.

In the present embodiment, as loci of a graph equivalent to those of the graphs in FIGS. 6A and 6B, a machining locus of, for example, a circular or a polygonal object that is machined by the laser machining apparatus according to the present embodiment and a machining locus that is calculated by the reading units via the respective filter units can be used. That is, eventually, the machining locus (curved line) on the object 304 has only to be precisely estimated; thus, it becomes possible to solve the optimization problem of the parameters of the filter units regardless of the time axis.

### Article Manufacturing Method

Next, an article manufacturing method of articles (such as components, materials, substrates, and semiconductor devices) that are manufactured by using the above-described laser machining apparatus will be described. Such an article is manufactured by using the above-described laser machining apparatus as follows. An object to be machined is irradiated with laser in which an optical path thereof is controlled by the mirrors of the galvano devices, and the object to be machined is, for example, drilled, trimmed, repaired, or marked. According to the present manufacturing method, articles with higher quality can be manufactured compared with those manufactured by an existing method.

### Other Embodiments

The first embodiment or the second embodiment of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-077386, filed Apr. 15, 2019 which is hereby incorporated by reference herein in its entirety.

What is claimed is:

1. A galvano device that rotates a mirror provided at a motor shaft by rotating a motor and changes a direction of light by allowing the mirror to reflect the light, comprising:
a sensor configured to detect a rotation angle of a motor rotating shaft; and
a filter configured to estimate a rotation angle of the mirror from a value output from the sensor,
wherein the rotation angle of the mirror is output from the filter.

2. The galvano device according to claim 1,
wherein a parameter to be used in the filter is obtained by calculation with reference to a resonance frequency that is obtained by structural analysis relative to a complex of the motor and the mirror.

3. A laser machining apparatus that machines an object by using laser, comprising:
a laser light source; and
a galvano device configured to control a direction of light from the laser light source, the galvano device comprising:
a sensor configured to detect a rotation angle of a motor rotating shaft; and
a filter configured to estimate a rotation angle of the mirror from a value output from the sensor,
wherein the rotation angle of the mirror is output from the filter.

4. The laser machining apparatus according to claim 3,
wherein the galvano device includes two galvano devices that have respective rotation axes orthogonal to each other.

5. The laser machining apparatus according to claim 4,
wherein a parameter of a filter of one of the two galvano devices and a parameter of a filter of the other one of the two galvano devices are optimized independently.

6. The laser machining apparatus according to claim 4,
wherein an integrated parameter set of a parameter of a filter of one of the two galvano devices and a parameter of a filter of the other one of the two galvano devices is optimized.
